(19) United States
(12) Patent Application Publication
(10) Pub. No.: US 2022/0118722 A1
(43) Pub. Date: Apr. 21, 2022

(54) CARBON FIBER SHELL HAVING ELASTOMER INNER OVERMOLD, AND METHOD TO FABRICATE A CARBON FIBER SHELL HAVING ELASTOMER INNER OVERMOLD

(71) Applicant: Air Design, S.A. de C.V., Tlalnepantla (MX)

(72) Inventors: Carlos Jose Avalos Sartorio, Morelos (MX); Miguel Jose Avalos Sartorio, Morelos (MX)

(73) Assignee: Air Design, S.A. de C.V., Tlalnepantla (MX)

(21) Appl. No.: 17/422,405

(22) PCT Filed: Jan. 9, 2020
(86) PCT No.: PCT/IB20/50158

§ 371 Date: Jul. 12, 2021

Related U.S. Application Data
(60) Provisional application No. 62/791,376, filed on Jan. 11, 2019.

(51) Int. Cl. B29C 70/48; C08J 5/24; B29B 11/08; B29K 63/00; B29K 307/04; B29K 21/00

(52) U.S. Cl. CPC B29C 70/48; C08J 5/243; B29K 2021/00; B29K 2063/00; B29K 2307/04; B29B 11/08

(57) ABSTRACT

In a method for manufacturing a composite shell, a carbon fiber is infused with a resin using a first mold to create a carbon fiber shell. A molding material is then injection molded onto the carbon fiber shell using a second mold to generate a molded shell. The molded shell is then trimmed to create a trimmed shell. A clear coating can then be applied to the trimmed shell to create the composite shell.

### CROSS REFERENCE TO RELATED APPLICATIONS

This patent application claims priority to U.S. Provisional Patent Application No. 62/791,376, filed Jan. 11, 2019, which is incorporated herein by reference in its entirety.

### BACKGROUND

The present disclosure is related to composite shells and the manufacture thereof, including carbon-fiber shells having an elastomer inner overmold.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIGS. 1A-1F illustrate a method of manufacturing a carbon fiber shell having elastomer inner overmold according to an exemplary embodiment of the disclosure.

FIG. 2A illustrates a carbon fiber shell according to an exemplary embodiment of the disclosure.

FIG. 2B illustrates a carbon fiber shell with an overmolded interior according to an exemplary embodiment of the disclosure.

FIG. 2C illustrates an overmolded carbon fiber shell following trimming according to an exemplary embodiment of the disclosure.

FIG. 2D illustrates an overmolded carbon fiber shell following a clearcoat application according to an exemplary embodiment of the disclosure.

FIG. 3 illustrates a flowchart of a method of manufacturing a carbon fiber shell having elastomer inner overmold according to an exemplary embodiment of the disclosure.

The exemplary embodiments of the present disclosure will be described with reference to the accompanying drawings. In the drawings, the same or similar reference signs are used for identical or similar components.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure is to provide a process to fabricate/manufacture a composite shell material. In an exemplary embodiment, the composite shell is applicable for automotive vehicles, motorcycles, boats, aircraft, trains, or other transportation devices. The present disclosure is not limited to transportation-related applications and the composite shell can be used in other aspects as would be understood by one of ordinary skill in the relevant arts.

In an exemplary embodiment, the composite shell is a carbon fiber shell having an inner overmolded elastomeric body. Advantageously, the composite shell of one or more embodiments combines the properties (e.g. look, feel, and/or structural properties) of carbon fiber with the properties and benefits of a controlled shape of the inner face of the composite shell to facilitate the fixing of the composite shell onto other surfaces.

In an exemplary embodiment, the composite shell can be applied to a wide variety of parts/areas of, for example, a vehicle and/or aircraft. In an exemplary embodiment, the composite shell is applied to non-structural parts/areas of, for example, a vehicle, motorcycles, aircraft, and/or other vessels, crafts, or structures. In an exemplary embodiment, the composite shell is used for the manufacturing of spoilers for vehicles. The disclosure is not limited to spoiler applications, and can be used in other vehicle, aircraft, and/or maritime vessels (e.g. boats) components. In exemplary embodiments, the composite shell can form external and/or interior portions of the vehicle/aircraft/vessel. These portions can include external and/or internal accessories, but are not limited thereto.

Advantageously, the composite shell according to exemplary embodiments provides high superficial strength (e.g. carbon fiber surface) on the outer surface combined with increased flexibility on the inner (e.g. overmolded elastomer) surface, which facilitates assembly of the shell onto another surface or component/part. These advantages are not realized with conventional carbon fiber parts. In an exemplary embodiment, the carbon fiber shell has a thickness of 0.5 to 1 mm, but is not limited thereto.

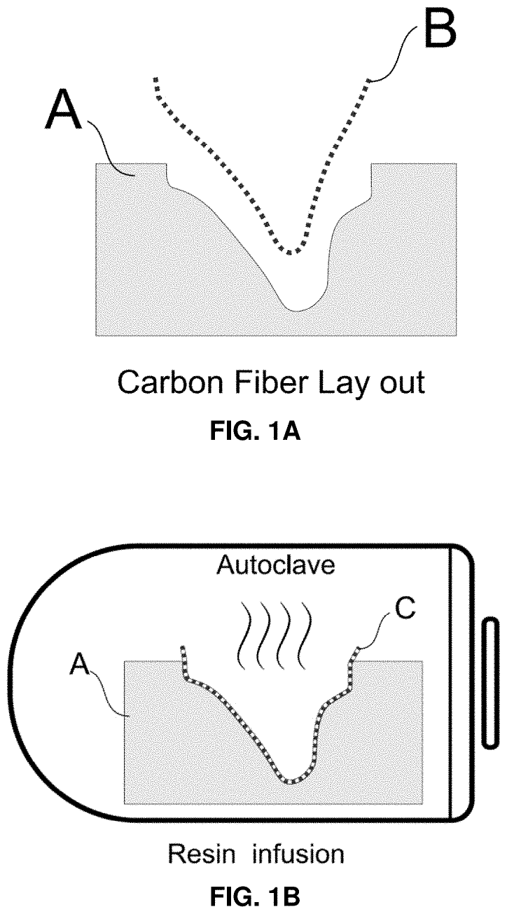

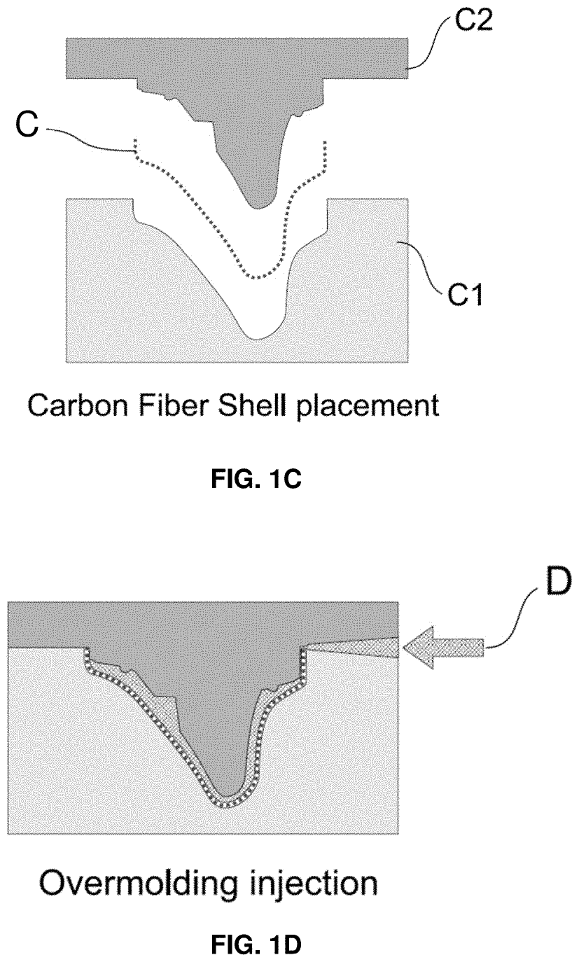

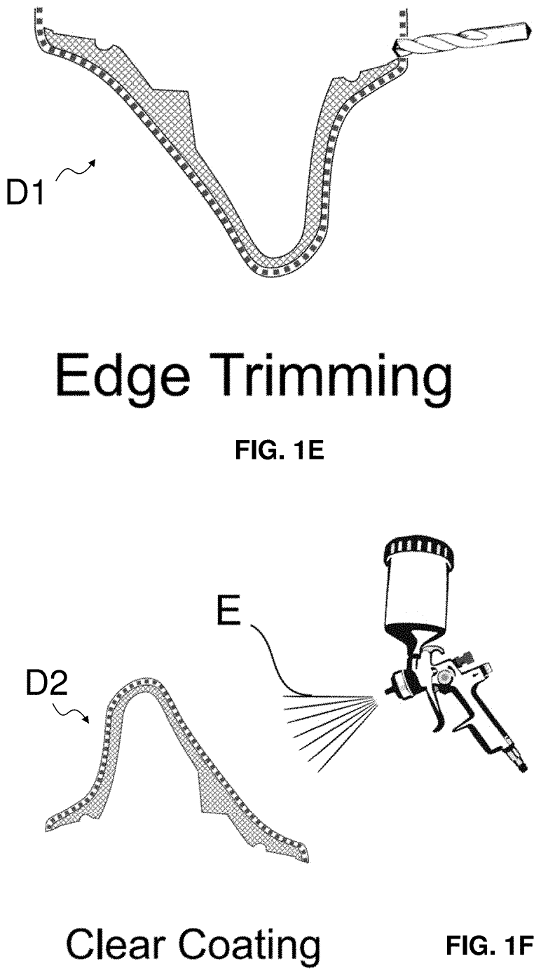

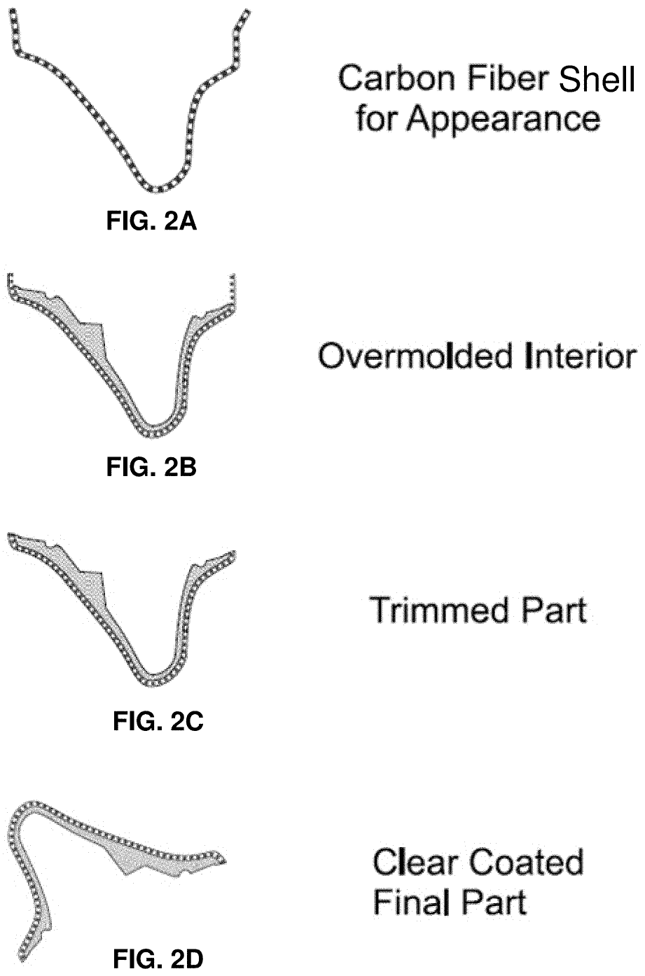

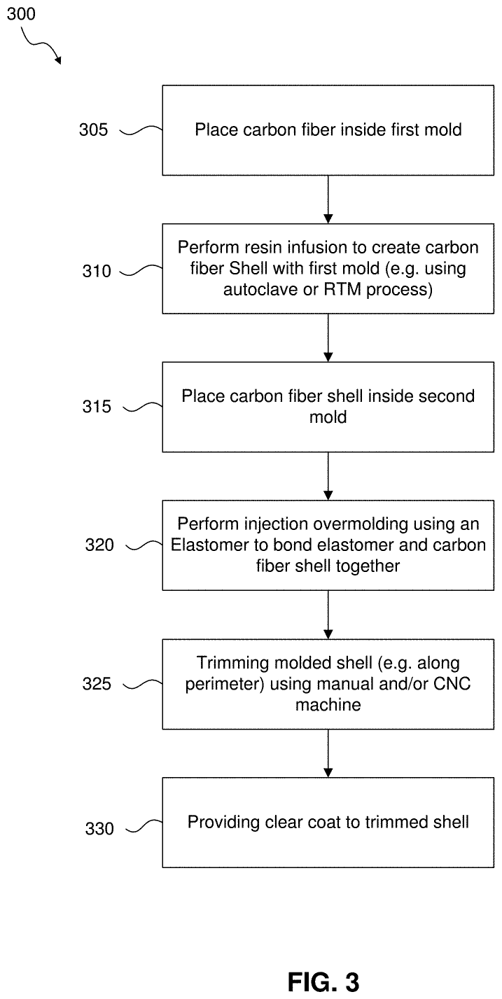

With reference to FIGS. 1A-1F and the flowchart shown in FIG. 3, a method to fabricate a composite carbon fiber and elastomer shell according to exemplary embodiments is described. FIG. 2 shows the examples of the composite shell during various operations of the fabrication method according to an exemplary embodiment.

At operation 305, and as shown in FIG. 1A, carbon fiber (B) is placed in a mold (A) (e.g. single-sided mold).

After operation 305, and as shown in FIG. 1B, the flowchart 300 transitions to operation 310, where a resin infusion operation is performed to create a carbon fiber shell (C) using the mold (A). In an exemplary embodiment, the resin fusion operation using an autoclave in which the carbon fiber mold are placed in a chamber configured to generate an elevated pressure (e.g. 7 bar) and/or temperature (e.g. 120-230 degrees Celsius) therein to infuse the resin with the carbon fiber. In another embodiment, the resin infusion is achieved using a resin transfer molding (RTM) process that includes, a closed mold that is sealed, heated, and placed under vacuum. In an exemplary aspect, the resin infusion operation is performed for 1-3 hours, but is not to this example duration.

An example of the carbon fiber used as the yarn is HexForce Carbon Fabric x2x Twill 193GSM, but is not limited thereto. An example of the resin infused with the carbon fiber is PRO-SET Infusion Epoxy (INF-114, INF-211), but is not limited thereto.

After operation 310 and as shown in FIG. 1C, the flowchart 300 transitions to operation 315, where the carbon fiber shell (C) resulting from the resin infusion operation is placed in a mold, such as a multi-part mold (C1 and C2). The mold C1 can be the same or different from mold A. The multi-part mold can include two mold parts (e.g. C1 and C2), but is not limited thereto.

After operation 315 and as shown in FIG. 1D, the flowchart 300 transitions to operation 320, where the multi-part mold (C1 and C2) is closed with the carbon fiber shell (C) housed therein.

At operation 320, the elastomer (D) is molded onto the carbon fiber shell (C) to generate a composite shell D1. In an exemplary aspect, an injection molding operation is performed to mold the elastomer (D) onto the carbon fiber shell (C). This injection molding operation (injection overmolding) bonds the elastomer and carbon fiber shell together. In an exemplary embodiment, the elastomer is, for example, RIMLINE SH87930-RUBINATE 8600, but is not limited thereto.

In an exemplary embodiment, the elastomer is provided at a temperature of, for example, 20 to 30° C., and/or the mold has a temperature of, for example, 35 to 40° C. The disclosure is not limited to these exemplary temperatures. In an exemplary embodiment, the elastomer is injection molded at a pressure of, for example, 190 bar, but is not limited thereto. The injection molding operation can be performed for 5-10 minutes, but is not limited thereto.

After operation 320 and as shown in FIG. 1E, the flowchart 300 transitions to operation 325, where the composite shell (D1) is removed from the injection mold and trimmed to provide a trimmed composite shell (D2). In an exemplary embodiment, the perimeter of the composite shell (D1), such as portions of the composite shell (D1) without elastomer bonded thereto are trimmed to remove these portions from the composite shell (D1). In an exemplary embodiment, the trimming operations can be a manual trimming using, for example, one or more cutting or grinding tools, and/or be performed using, for example, a computer numerical control (CNC) cutting device.

After operation 325 and as shown in FIG. 1F, the flowchart 300 transitions to operation 330, where the trimmed composite shell (D2) is coated with one or more materials that can provide increased durability for the composite shell. For example, the coating material can provide increased abrasive resistance, UV light blocking, chemical resistance, or the like. The coating material can be a clearcoat material. The clearcoat material can be, for example, transparent. The clearcoat can be glossy or matte. The coating material can be applied using a spray system in an exemplary embodiment, but is not limited thereto.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

A Mold for resin transfer
B Carbon Fiber
C Carbon Fiber Shell
C1 Mold for Injection Female Side
C2 Mold for Injection Male Side
D Elastomer
D1 Composite shell (untrimmed)
D2 Composite shell (trimmed)
E Clearcoat

1. A method of manufacturing a composite shell, comprising:
infusing carbon fiber with a resin using a first mold to create a carbon fiber shell;
injection molding a molding material onto the carbon fiber shell using a second mold to generate a molded shell;
trimming the molded shell to create a trimmed shell; and
clear coating the trimmed shell to create the composite shell.

2. The method according to claim 1, wherein the first mold is a single-sided mold.

3. The method according to claim 1, wherein the second mold is different from the first mold.

4. The method according to claim 1, wherein the second mold is a multi-part mold having at least two mold parts.

5. The method according to claim 1, wherein infusing the carbon fiber with the resin comprises subjecting the carbon fiber and the resin to an elevated temperature with respect to an ambient temperature and/or an elevated pressure with respect to an ambient pressure.

6. The method according to claim 1, wherein the first mold is a single-sided mold and the second mold is a multi-part mold having at least two mold parts.

7. The method according to claim 1, wherein the resin is infused with the carbon fiber using an autoclave.

8. The method according to claim 1, wherein the resin is infused with the carbon fiber using a resin transfer molding (RTM) process.

9. The method according to claim 5, wherein the elevated temperature is 120-230 degrees Celsius and the elevated pressure is at least 7 bar.

10. The method according to claim 1, wherein the resin infused with the carbon fiber is an epoxy.

11. The method according to claim 1, wherein the molding material is an elastomer.

12. The method according to claim 1, wherein the injection molding is performed at a temperature of 35 to 40° C., the molding material is provided at a temperature of 20 to 30° C., and/or the molding material is injection molded at a pressure of 190 bar.

13. The method according to claim 1, wherein the injection molding is performed at a temperature of 35 to 40° C., the molding material is provided at a temperature of 20 to 30° C., and the molding material is injection molded at a pressure of 190 bar.

14. The method according to claim 1, wherein the trimming removes portions of the molded shell that include only the carbon fiber shell.

15. The method according to claim 1, wherein the trimming removes portions of the molded shell along the perimeter.

16. The method according to claim 1, wherein the clear coating at least partially blocks ultraviolet light and/or provides an increased chemical resistance.

17. The method according to claim 1, wherein the composite shell is a carbon fiber shell having an elastomer inner overmold.

18. A non-transitory computer-readable storage medium with an executable program stored thereon, wherein the program instructs a processor to perform the method of claim 1.

19. A composite shell, comprising:
a carbon fiber shell; and
an elastomer molded onto the carbon fiber shell.

20. The composite shell of claim 19, wherein the elastomer is molded onto an interior surface of the carbon fiber shell.
